(19) United States
(12) Patent Application Publication
(10) Pub. No.: US 2015/0066976 A1
(43) Pub. Date: Mar. 5, 2015

(54) AUTOMATED IDENTIFICATION OF RECURRING TEXT

(71) Applicant: Lighthouse Document Technologies, Inc. (d/b/a Lighthouse eDiscovery), Seattle, WA (US)

(72) Inventors: Christopher Dahl, Seattle, WA (US); Geoffrey Alan David Belger, Seattle, WA (US)

(73) Assignee: Lighthouse Document Technologies, Inc. (d/b/a Lighthouse eDiscovery), Seattle, WA (US)

(21) Appl. No.: 14/072,595

(22) Filed: Nov. 5, 2013

Related U.S. Application Data
(60) Provisional application No. 61/870,697, filed on Aug. 27, 2013.

(51) Int. Cl. G06F 17/30

(52) U.S. Cl. CPC G06F 17/30011; G06F 17/30675
USPC 707/769

(57) ABSTRACT

In embodiments, one or more computer-readable media may have instructions stored thereon which, when executed by a processor of a computing device, provide the computing device with a recurring text identification service. The recurring text identification service may be configured, in some embodiments, to receive a request to identify recurring text within a plurality of documents. The recurring text identification service may be further configured to analyze individual segments of the plurality of documents to generate segment identifiers respectively associated with the segments. In embodiments, the segment identifiers may be based on content of the segments. In embodiments, segments with the same content may have equivalent segment identifiers. The recurring text identification service may further be configured to generate a distribution of the segment identifiers and may enable the distribution of segment identifiers to be used to streamline identification of recurring text within the plurality of documents.

### CROSS REFERENCE TO RELATED APPLICATIONS

This application claims the benefit of U.S. Provisional Application No. 61/870,697 filed on Aug. 27, 2013, and entitled AUTOMATED IDENTIFICATION OF RECURRING TEXT, the subject matter of which is incorporated herein by reference.

### TECHNICAL FIELD

Embodiments of the present disclosure are related to the field of information processing and, in particular, to identification of recurring text within documents.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

When documents are being produced based upon content of the document, such as in electronic discovery during litigation or government investigations, or sharing corporate information in mergers and acquisitions, it may be necessary to filter through documents, when processing the documents for production, to prevent certain documents from being produced. For example, in electronic discovery during litigation, it may be necessary to filter out any documents that may be privileged to prevent them from being produced for an opposing party. Currently, the only method for accomplishing this is to perform a search of the documents for certain keywords indicative of privilege and then manually analyze the documents to determine each individual documents privilege status. This manual process may be very costly and time consuming. The number of documents identified initially as privileged in such cases may include a great number of documents identified as privileged due solely to some boilerplate recurring text included in the documents. In such instances a person reviewing the documents must manually identify instances where the sole reason a hit was returned on the document was due to this recurring text.

### BRIEF DESCRIPTION OF THE DRAWINGS

FIG. 1 depicts an illustrative recurring text identification system according to some embodiments of the present disclosure.

FIG. 2 depicts an illustrative segment of a document.

FIG. 3 depicts an illustrative recurring text identification process flow according to some embodiments of the present disclosure.

FIG. 4 depicts an illustrative computing device incorporated with the teachings of the present disclosure, according to some embodiments.

### DETAILED DESCRIPTION OF ILLUSTRATIVE EMBODIMENTS

In embodiments, one or more computer-readable media may have instructions stored thereon which, when executed by a processor of a computing device, provide the computing device with a recurring text identification service. The recurring text identification service may be configured, in some embodiments, to receive a request to identify recurring text within a plurality of documents. The recurring text identification service may be further configured to analyze individual segments of the plurality of documents to generate segment identifiers respectively associated with the segments. In embodiments, the segment identifiers may be based on content of the segments. In embodiments, segments with the same content may have equivalent segment identifiers. The recurring text identification service may further be configured to generate a distribution of the segment identifiers and may enable the distribution of segment identifiers to be used to streamline identification of recurring text within the plurality of documents. For example, in embodiments, the documents may be text based documents created by one or more word processing applications. The segments may be paragraphs contained within the documents. The recurring text may be, for example, boiler plate language, such as the footer of an email. Other embodiments may be described and/or claimed within.

In the following detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

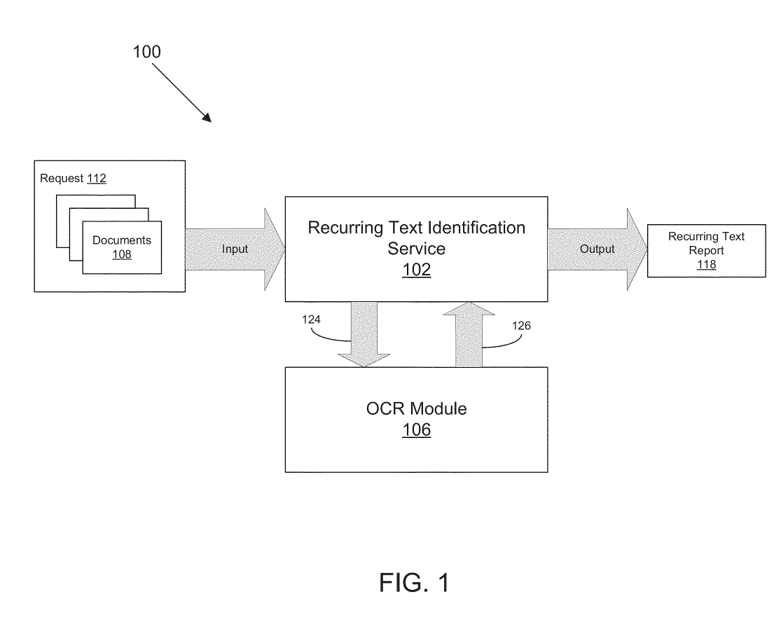

FIG. 1 depicts an illustrative recurring text identification system 100 according to some embodiments of the present disclosure. In embodiments, recurring text identification system 100 may include recurring text identification service 102 and optical character recognition (OCR) module 106, operatively coupled with each other as shown. Recurring text identification service 102 may be configured to take as input a recurring text identification request, e.g., request 112. Request 112 may include documents 108. Alternatively, documents 108 may be separately provided. In some embodiments, documents 108 may include copies of documents, images of documents, an electronic link to copies of documents or images of documents, or any combination thereof.

In embodiments, recurring text identification service 102 may be communicatively coupled with OCR module 106 in a wide range of manners. The communicative coupling may be accomplished via any appropriate mechanism, including, but not limited to, a system bus, local area network (LAN), and/or wide area network (WAN). A LAN or WAN may include one or more wired and/or wireless, private and/or public networks, such as the Internet.

In some embodiments documents 108 may contain images of documents that may have no associated text. In such embodiments it may be necessary to perform an OCR process on the image of the document to extract text from the image. As depicted here, recurring text identification service 102 may send request 124 to OCR module 106 containing document images or links to document images for OCR module 106 to process. OCR module 106 may be configured to process each document image of request 124 and extract associated text from each document image.

In some embodiments, recurring text identification service 102 may be configured to send request 124 on an image-by-image basis, wherein request 124 is sent for each document image available in documents 108. In other embodiments, recurring text identification service 102 may be configured to determine a group of images to send to OCR module 106 to extract text from the group of images. In such embodiments, the group may be determined by a predetermined number of document images to group together up to, and including, all available document images of documents 108. Furthermore, recurring text identification service 102 may be configured to send request 124 synchronously or asynchronously and OCR module 106 may be configured to process the request correspondingly without departing from the scope of this disclosure. It will be appreciated that, in some embodiments, documents 108 may not include any document images, or any OCR processing may be performed prior to recurring text identification service 102 receiving request 112. In such embodiments OCR module 106 may be omitted.

Recurring text identification service 102 may be configured to partition individual documents of documents 108 into segments to be processed. For example, recurring text identification service 102 may partition the individual documents based upon paragraph break indicators, such as carriage returns and/or line feeds. Recurring text identification module 102 may be further configured to analyze each segment and generate a content based identifier associated with the segment.

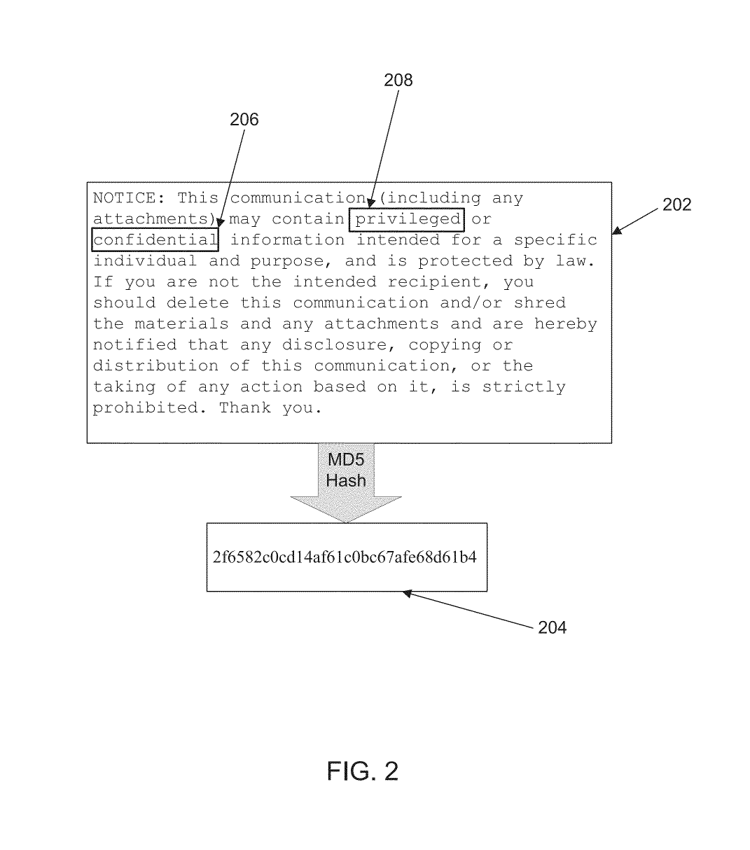

The content based identifier may be unique to the content contained within the segment, such that any segment having the same content based identifier may contain the same content. In embodiments, the content based identifier may be generated by applying a hash function to the content of the segment, such as that depicted in FIG. 2. In embodiments, recurring text identification service 102 may be configured to generate a recurring text report 118 utilizing the content based identifiers for output.

The recurring text report may contain a listing of content based identifiers occurring within documents 108. For example, recurring text report 118 may contain a listing of content based identifiers, the number of occurrences of each content based identifier, the content associated with the content based identifier, and/or a list of the documents that contain the content based identifier. In some embodiments, recurring text report 118 may be output to another application or service, such as a management application. In other embodiments, recurring text report 118 may be output to a user of recurring text identification service 102.

In some embodiments, recurring text report 118 may be provided to a user in a format where the user may select content based identifiers from the report as recurring text that may be ignored when performing further processing on documents 108. For example, documents 108 may contain a number of emails, each having a footer, such as that depicted in FIG. 2. A user may select the content based identifier associated with the footer to exclude the footer from further processing. In embodiments, not depicted herein, the user may select the content based identifiers the user wishes to ignore and may submit these identifiers to the recurring text identification service 102. The recurring text identification service 102 may then further process documents 108, for example, by indexing documents 108 for searching. In indexing documents 108 for searching, the recurring text identification service 102 may ignore, for indexing purposes, segments with content that corresponds to a content based identifier selected by the user.

In some embodiments, recurring text identification service 102 may interact with one or more management applications, not pictured. Such a management application may generate request 112. In embodiments, the management application may provide real-time status of request 112 to a user of the management application. For example, the management application may be a third party application associated with a document review platform. In some embodiments, to generate request 112, the management application may be configured to allow a user of the management application to select documents, e.g., from a database or data store, to include in documents 108. The selected documents may be packaged together and submitted as request 112.

FIG. 2 depicts an illustrative segment 202 of a document. As depicted here, segment 202 may be a footer of an email. Segment 202 may be processed by, for example, recurring text identification service 102 of FIG. 1 to generate a content based identifier 204. Content based identifier 204 may be generated by applying a hash function to segment 202. As depicted here, a message digest 5 (MD5) hash function has been applied to segment 202 to produce the content based identifier 204; however, the use of an MD5 hash is for illustrative purposes only and is not to be limiting of this disclosure. It will be appreciated that any suitable method of arriving at a content based identifier is contemplated by this disclosure.

As discussed in this disclosure, segment 202 may be selected to be ignored in further processing of the document(s). This may be due, for example, to hits in segment 202 returned from a search run on the document(s). For example, if a user is wishing to identify privileged and/or confidential documents, the user may perform a search for terms indicative of such an identification. For illustrative purposes only, these terms may be represented by terms 206 and 208. Therefore a search for terms 206 and 208 may result in any document containing segment 202 being identified as privileged and/or confidential. Because terms 206 and 208 may occur only within segment 202 of these document(s), the user may wish to ignore segments having this same content in searching the document(s). By ignoring this segment, the noise in the search may be reduced as only those occurrences of terms 206 and 208 outside segment 202 may be returned as hits.

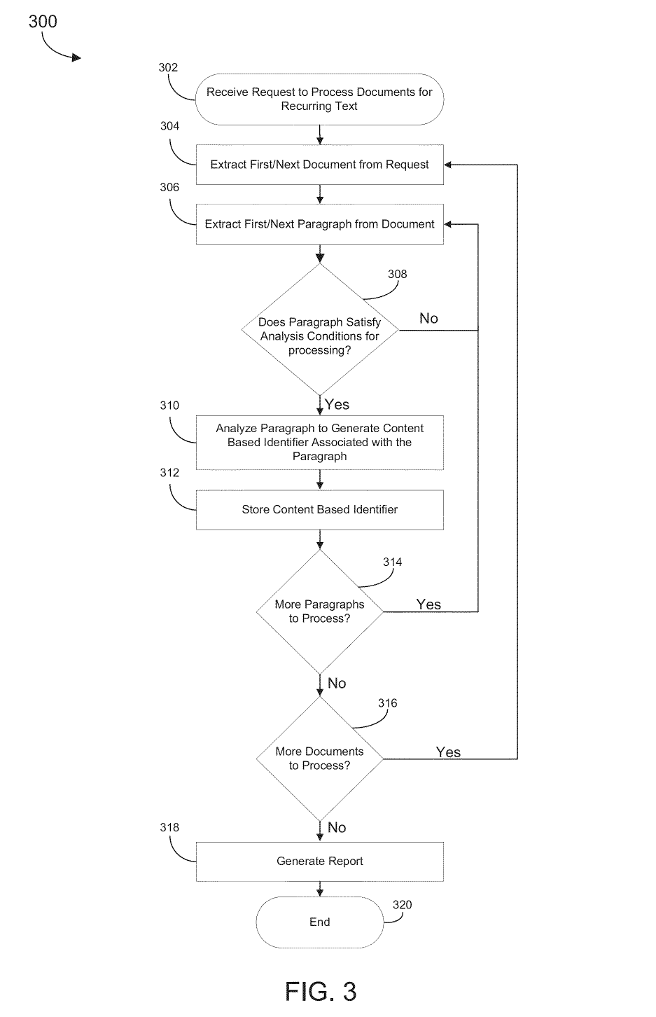

FIG. 3 depicts an illustrative recurring text identification process flow 300 according to some embodiments of the present disclosure. The process may begin at block 302 where a request to process documents for recurring text is received. In embodiments, the request may contain copies of documents to be processed and/or links to documents to be processed. Alternatively, the documents may be separately provided. The documents may be any type of text document containing identifiable text such as, but not limited to, any documents created by a word processing application and/or email application or text associated with an image produced by an optical character recognition (OCR) process run on the image to extract text therefrom.

In block 304, a document may be extracted from the request. The document may be a first document contained within the request or it may be a subsequent document depending on the stage of processing the request. In embodiments, the document may be extracted merely by opening the document via a copy of the document, or link to the document, provided with the request. In other embodiments, the documents in the request may be encrypted for increased security and to extract the documents may further involve decryption of the documents.

In block 306, a paragraph may be extracted from the currently extracted document. The paragraph may be a first or a subsequent paragraph of the document depending on the stage of processing the document. In embodiments, the paragraph may be extracted by identifying paragraph break indicators in the document. Paragraph break indicators may include, but are not limited to, newline characters, or carriage return and/or line feed characters in the document. In embodiments, the paragraphs may be iterated through within the document. In other embodiments, not depicted by this process flow, all paragraphs may be extracted at once and placed into a database, queue, array, or other appropriate data structure for processing.

In block 308, a determination may be made as to whether the current paragraph satisfies one or more analysis conditions for either inclusion or exclusion from processing. In embodiments, analysis conditions may be represented by a character length requirement such as a minimum or maximum character length which may be required for the paragraph to be processed. For example, a paragraph containing only 10 characters may be excluded from the processing depicted in blocks 310 and 312. Another analysis condition may be represented by a predefined character pattern which, if matched by the current paragraph, may indicate that the paragraph is to be either included or excluded from processing. For example, an email header indicating the address of origin or destination address of an email, may be excluded from processing by identifying the pattern “to:” or “from:” and excluding paragraphs matching this pattern. This pattern may be defined, for example, using regular expressions. It will be appreciated that these analysis conditions are merely meant to be illustrative and any such condition for inclusion or exclusion of a paragraph from processing is contemplated by this disclosure.

If analysis conditions are not met for processing of the current paragraph, the process may return to block 306 where the next paragraph may be extracted for processing. If analysis conditions are met for processing the current paragraph, then the process may proceed to block 310 where the current paragraph is analyzed to determine a content based identifier to associate with the paragraph. In some embodiments, this may be accomplished by applying a hash function to the text contained within the current paragraph to derive a hash value associated with the current paragraph. For example, as depicted in FIG. 2, above, a message-digest 5 (MD5) hash function may be applied to the paragraph to arrive at a 128-bit content based identifier associated with the paragraph. In embodiments, the content based identifier may be arrived at by ignoring any white space or punctuation occurring within the text of the current paragraph, such that all paragraphs containing the same text have the same content based identifier regardless of punctuation or spacing of characters within the paragraphs.

Once a content based identifier associated with the current paragraph has been derived, the content based identifier may be stored in block 312 for future reference. In some embodiments, the content based identifier may be stored on a document by document basis, for example, by being stored in a table, database, or other similar repository associated with the current document. In other embodiments, the content based identifier may be stored on a request by request basis, for example by being stored in a table, database, or other similar repository associated with the current request. In still other embodiments, the content based identifier may be stored in a universal repository, for example by being stored in a cross-request database. In any of these embodiments, where the unique value may be stored in a database, the database may be a relational database which may correlate individual content based identifiers with the text that produced the individual content based identifier and any documents containing text having the same content based identifier.

After the content based identifier has been stored, the process may continue to block 314 where a determination may be made as to whether the current document contains more paragraphs to process. If the current document does contain more paragraphs to process, the process may return to block 306 where the next paragraph may be extracted. If the current document does not contain more paragraphs to be processed then the process may continue to block 316 where a determination may be made as to whether the current request contains more documents to process. If the current request does contain more documents to process, the process may return to block 304 where the next document may be extracted. If the current request does not contain more documents to be processed then the process may continue to block 318.

In block 318, a report may be generated. This report may be generated from the content based identifiers identified while processing the request. For instance, this report may be generated by querying the database described above based upon a content based identifier assigned to the request. The report may include a record of each individual content based identifier encountered in processing the request, the number of times the content based identifier was encountered while processing the request, the text utilized to derive the content based identifier, and one or more documents containing the text that derived the content based identifier. In embodiments, the report may be limited based on a number of occurrences of the content based identifier. For example, a user that submitted the request may only be interested in any text that recurs within the documents of the request. In such a scenario, the user may limit the report to only those content based identifiers that occur more than once.

In embodiments, the content based identifiers derived from the text may be further utilized to refine searching within documents. For instance, in the area of electronic discovery, documents containing certain text may be excluded from production based upon text that identifies the document as privileged. Where the text that excludes a document from production based upon privilege occurs in recurring text, such as, for example, a footer of an email, it may desirable to determine if the only text that excludes the document from production is the recurring text. If the only text that excludes the document from production is found in the footer of the document, it may be necessary to include the document for production purposes and therefore the text in the footer may be ignored. The footer may be ignored, for example, by utilizing the content based identifier associated with the text of the footer to exclude the text of the footer from consideration when determining whether the document is privileged. The content based identifier may be further utilized to exclude recurring text, such as the footer discussed above, from returning a hit on a search term, where the search term is found in recurring text. This may be accomplished, for example, by utilizing the content based identifier associated with the text of the footer to exclude the text of the footer from consideration when searching the document. Another utilization for the content based identifier may be in scenarios where documents are being indexed for searching. In such scenarios it may be desirable to exclude recurring text, such as the footer discussed above, from being indexed. This may result in increased efficiency of the indexing, because the excluded text is not indexed, and also may result in the indexed text being more reliable by eliminating noise caused by search results produced by any recurring text. While the examples above were restricted to footers of an email, it will be appreciated that this is merely for illustrative purposes only and that any type of text commonly recurring is contemplated by this disclosure. Examples of recurring text may include, but are not limited to, signature line(s) of an email, legal disclaimers placed within text documents, boilerplate language used within text documents, etc.

In embodiments, process 300 may be implemented in hardware and/or software. In hardware embodiments, process 300 may be implemented in application specific integrated circuits (ASIC), or programmable circuits, such as Field Programmable Gate Arrays, programmed with logic to practice process 300. In a hardware/software implementation, process 300 may be implemented with software modules configured to be operated by the underlying processor. The software modules may be implemented in the native instructions of the underlying processor(s), or in higher level languages with compiler support to compile the high level instructions into the native instructions of the underlying processor(s).

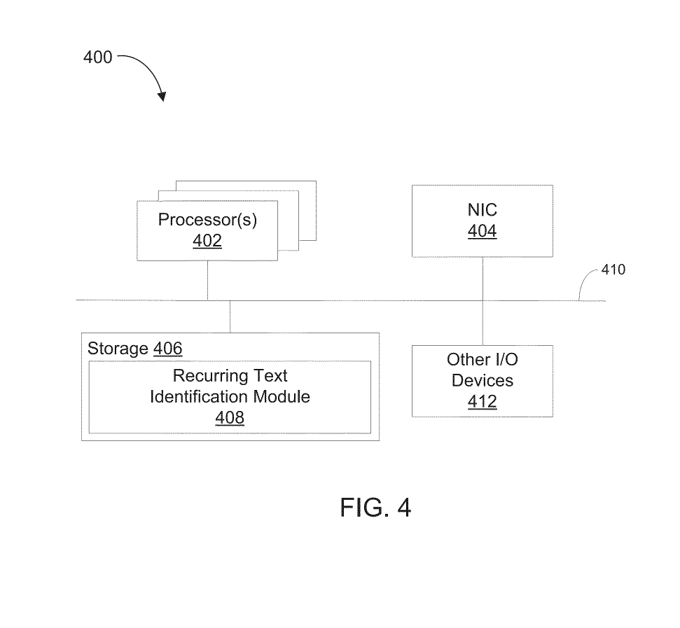

FIG. 4 depicts an illustrative configuration of a computing device 400 incorporated with the teachings of the present disclosure according to some embodiments. Computing device 400 may comprise processor(s) 402, network interface card (NIC) 404, storage 406, containing recurring text identification module 408, and other I/O devices 412. Processor(s) 402, NIC 404, storage 406, and other I/O devices 412 may all be coupled together utilizing system bus 410.

Processor(s) 402 may, in embodiments, be comprised of one or more single core and/or one or more multi-core processors, or any combination thereof. In embodiments with more than one processor the processors may be of the same type, i.e. homogeneous, or they may be of differing types, i.e. heterogenous. This disclosure is equally applicable regardless of type and/or number of processors.

In embodiments, NIC 404 may be used by computing device 400 to access a network. In embodiments, NIC 404 may be used to access a wired or wireless network; this disclosure is equally applicable. NIC 404 may also be referred to herein as a network adapter, LAN adapter, or wireless NIC which may be considered synonymous for purposes of this disclosure, unless the context clearly indicates otherwise; and thus, the terms may be used interchangeably. In embodiments, NIC 404 may be configured to receive the request to process documents for recurring text, discussed above in reference to FIGS. 1 and 3, from a remote computer and may forward the request to recurring text identification module 408 by way of system bus 410.

In embodiments, storage 406 may be any type of computer-readable storage medium or any combination of differing types of computer-readable storage media. Storage 406 may include volatile and non-volatile/persistent storage. Volatile storage may include e.g., dynamic random access memory (DRAM). Non-volatile/persistent storage 406 may include, but is not limited to, a solid state drive (SSD), a magnetic or optical disk hard drive, flash memory, or any multiple or combination thereof.

In embodiments recurring text identification module 408 may be implemented as software, firmware, or any combination thereof. In some embodiments, recurring text identification module may comprise one or more instructions that, when executed by processor(s) 402, cause computing device 400 to perform one or more operations of the process described in reference to FIGS. 1 and 3, above, or any other processes described herein.

For the purposes of this description, a computer-usable or computer-readable medium can be any medium that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Embodiments of the disclosure can take the form of an entirely hardware embodiment, an entirely software embodiment or an embodiment containing both hardware and software elements. In various embodiments, software, may include, but is not limited to, firmware, resident software, microcode, and the like. Furthermore, the disclosure can take the form of a computer program product accessible from a computer-usable or computer-readable medium providing program code for use by or in connection with a computer or any instruction execution system.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the disclosure. This application is intended to cover any adaptations or variations of the embodiments discussed herein. Therefore, it is manifestly intended that the embodiments of the disclosure be limited only by the claims and the equivalents thereof.

What is claimed is:

1. One or more computer-readable media having instructions stored thereon which, when executed by a processor of a computing device, cause the computing device to provide a recurring text identification service configured to:
receive a request to identify recurring text within a plurality of documents;
analyze individual segments of the plurality of documents to generate segment identifiers respectively associated with the segments, wherein the segment identifiers are based at least in part on content of the segments, and wherein segments with the same content have equivalent segment identifiers;
generate a distribution of the segment identifiers; and
enable the distribution of segment identifiers to be used to streamline identification of recurring text within the plurality of documents.

2. The computer-readable media of claim 1, wherein to enable the distribution of segment identifiers the recurring text identification service is further configure to create and output a report of the distribution of the segment identifiers.

3. The computer-readable media of claim 2, wherein to output comprises output to a display with the segment identifiers being selectable by a user, wherein the recurring text identification service is further configured to receive segment identifier selections of the user, and wherein the recurring text identification service is also further configured to streamline identification of recurring text within the plurality of documents by inclusion of only segments of the plurality of documents having a selected or equivalent segment identifier as recurring text.

4. The computer-readable media of claim 3, wherein the recurring text identification service is further configured to generate a plurality of indices to index only those segments not included as recurring text to facilitate searching for content within the plurality of documents.

5. The computer-readable media of claim 1, wherein generation of a segment identifier for a segment includes application of a hash function to the content of the segment.

6. The computer-readable media of claim 5, wherein the hash function is a message-digest 5 (MD5) hash function.

7. The computer-readable media of claim 1, wherein the recurring text identification service is further configured to partition each of the plurality of documents into a plurality of segments; wherein partition of each document is based at least in part on paragraph break indicators contained within the document.

8. The computer-readable media of claim 1, wherein the recurring text identification service is further configured to determine whether the content of each individual segment meets one or more analysis conditions and only analyzing the individual segment if the segment meets the one or more analysis conditions.

9. The computer-readable media of claim 8, wherein the one or more analysis conditions include at least one of a character length of the content of a segment or a predefined character pattern of the respective segment.

10. A system for identifying recurring text contained within one or more documents comprising:
a processor; and
a recurring text identification service configured to cause the processor to:
receive a request to identify recurring text within a plurality of documents;
analyze individual segments of the plurality of documents to generate segment identifiers respectively associated with the segments, wherein the segment identifiers are based at least in part on content of the segments, and wherein segments with the same content have equivalent segment identifiers;
generate a distribution of the segment identifiers; and
enable the distribution of segment identifiers to be used to streamline identification of recurring text within the plurality of documents.

11. The system of claim 10, wherein to enable the distribution of segment identifiers the recurring text identification service further configures the processor to create and output a report of the distribution of the segment identifiers.

12. The system of claim 11, wherein the system further comprises a display and to output comprises output to the display with the segment identifiers being selectable by a user, wherein the recurring text identification service further configures the processor to receive segment identifier selections of the user, and wherein the recurring text identification service also further configures the processor to streamline identification of recurring text within the plurality of documents by inclusion of only segments of the plurality of documents having a selected or equivalent segment identifier as recurring text.

13. The system of claim 12, wherein the recurring text identification service further configures the processor to generate a plurality of indices to index only those segments not included as recurring text to facilitate searching for content within the plurality of documents.

14. The system of claim 10, wherein generation of a segment identifier for a segment includes application of a hash function to the content of the segment.

15. The system of claim 14, wherein the hash function is a message-digest 5 (MD5) hash function.

16. The system of claim 10, wherein the recurring text identification service further configures the processor to partition each of the plurality of documents into a plurality of segments; wherein partition of each document is based at least in part on paragraph break indicators contained within the document.

17. The system of claim 10, wherein the recurring text identification service further configures the processor to determine whether the content of each individual segment meets one or more analysis conditions and only analyzing the individual segment if the segment meets the one or more analysis conditions.

18. The system of claim 17, wherein the one or more analysis conditions include at least one of a character length of the content of a segment or a predefined character pattern of the respective segment.

19. A computer-implemented method for identifying recurring text in one or more documents comprising:
receiving, by a recurring text identification service of a computing device, a request to identify recurring text within a plurality of documents;
analyzing, by the recurring text identification service, individual segments of the plurality of documents to generate segment identifiers respectively associated with the segments, wherein the segment identifiers are based at least in part on content of the segments, and wherein segments with the same content have equivalent segment identifiers;
generating, by the recurring text identification service, a distribution of the segment identifiers; and
enabling, by the recurring text identification service, the distribution of segment identifiers to be used in streamlining identification of recurring text within the plurality of documents.

20. The computer-implemented method of claim 19, wherein enabling the distribution of segment identifiers further comprises creating and outputting a report of the distribution of the segment identifiers.

21. The computer-implemented method of claim 20, wherein outputting comprises outputting to a display with the segment identifiers being selectable by a user, and further comprising receiving, by the recurring text identification service, segment identifier selections of the user and wherein streamlining further comprises including, by the recurring text identification service, only segments of the plurality of documents having selected or equivalent segment identifier from further processing as recurring text.

22. The computer-implemented method of claim 21, further comprising generating, by the recurring text identification service, a plurality of indices to index only those segments not included as recurring text to facilitate searching for content within the plurality of documents.

23. The computer-implemented method of claim 19, wherein generating a segment identifier for a segment includes applying a hash function to the content of the segment.

24. The computer-implemented method of claim 23, wherein the hash function is a message-digest 5 (MD5) hash function.

25. The computer-implemented method of claim 19, further comprising partitioning, by the recurring text identification service, each of the plurality of documents into a plurality of segments; wherein partitioning each document is based at least in part on paragraph break indicators contained within the document.

26. The computer-implemented method of claim 19, further comprising determining whether the content of each individual segment meets one or more analysis conditions and only analyzing the individual segment if the segment meets the one or more analysis conditions.

27. The computer-implemented method of claim 26, wherein the one or more analysis conditions include at least one of a character length of the content of a segment or a predefined character pattern of the respective segment.
